(19) United States
(12) Patent Application Publication
(10) Pub. No.: US 2011/0181895 A1
(43) Pub. Date: Jul. 28, 2011

(54) IMAGE PROCESSING APPARATUS AND IMAGE PROCESSING METHOD

(75) Inventor: Maho Ooyanagi, Tokyo (JP)

(73) Assignee: CANON KABUSHIKI KAISHA, Tokyo (JP)

(21) Appl. No.: 12/971,268

(22) Filed: Dec. 17, 2010

(30) Foreign Application Priority Data
Jan. 25, 2010 (JP) 2010-013119

(51) Int. Cl. H04N 1/405; G06K 15/02

(52) U.S. Cl. 358/1.2; 358/3.06

(57) ABSTRACT

Conventionally in a case of storing image data in an HDD, JPEG compression is executed to the image data for reducing the data size thereof and then the image data is stored. However, there are some cases where when the JPEG compression is executed to the image data including the copy-forgery-inhibited pattern and the like, degradation in image quality occurs. In regard to the image data including the copy-forgery-inhibited pattern and the like, the halftone processing is executed by the halftone processing unit without irreversible compression. Therefore, the image data can be stored in the HDD and like in a state of being small in a data size and with the image degradation restricted.

### BACKGROUND OF THE INVENTION

1. Field of the Invention

This invention relates to an image processing apparatus and an image processing method.

2. Description of the Related Art

There is conventionally known a technology in which a computer transmits document data (data such as sentences, graphics and tables) and copy-forgery-inhibited pattern data to a printer which synthesizes the two kinds of the data, and thereafter, synthesized image data (document data with the copy-forgery-inhibited pattern) obtained by the combination is printed on a plain sheet to produce an original text book.

Here, the copy-forgery-inhibited pattern will be briefly explained. The copy-forgery-inhibited pattern expresses information such as character columns in a state of being hard to be recognized with human eyes (in a hidden state) and is formed of a remaining region and a disappearing region. The remaining region is a region where relatively large dots (for example, black pixel group) are arranged and the disappearing region is a region where relatively small dots (for example, black isolation pixel) are arranged. “The remaining” means the event that an image in the original text book is reproduced on a copy object. “The disappearing” means the event that an image in the original text book is not reproduced on a copy object (the image becomes thin in density or completely disappears). A reflection density of each of the remaining region and the disappearing region per constant area is the substantially the same on the original text book. Therefore, in the state of the original text book, human eyes can not recognize that character columns and the like are expressed thereon, but when the original text book is copied, the character columns and the like embedded on the copy object rise to the surface. Therefore, in some cases, the copy-forgery-inhibited pattern is called a copy-restricting copy-forgery-inhibited pattern. It should be noted that the reflection density is measured by a reflection density meter.

In regard to the document data with such copy-forgery-inhibited pattern, since a data size thereof is more likely to increase, it is general to reduce the data size by JPEG compression for reducing processing loads in a printer. For example, Japanese Patent Laid-Open No. 2008-028485 discloses the technology of efficiently reducing a size of the document data with the copy-forgery-inhibited pattern by JPEG compression.

However, when the JPEG compression is made to the synthesized image data such as the document data with the copy-forgery-inhibited pattern, data of a high frequency component is eliminated, thereby possibly changing a portion of a black pixel constituting the copy-forgery-inhibited pattern into a gray pixel group. Further, the binarization creates a phenomenon, such as occurrence of a region in which black isolation pixels (small dots) are originally supposed to be emitted, a black pixel group (dot having an intermediate size) is emitted or in reverse any dot is not emitted. Therefore, in some cases, the copy-forgery-inhibited pattern data included in the synthesized image data is destroyed. As a result, there occurs a problem that even if an original text book obtained by printing the document data with the copy-forgery-inhibited pattern is copied, the character columns and the like which are originally supposed to rise to the surface do not rise to the surface.

The aforementioned problem, not limited to the document data with the copy-forgery-inhibited pattern, possibly occurs. That is, it is expected that the above problem likewise occurs in the synthesized image data including an image such as a two-dimensional code such as QR code, glyphCode (registered trademark) as a dot type barcode or LVBC (Low Visibility Barcode) used for digital watermark.

### SUMMARY OF THE INVENTION

For solving the above problem, an image processing apparatus according to the present invention includes the following configuration.

An image processing apparatus comprises a first halftone processing unit configured to execute halftone processing to image data, a first image data encoding unit configured to execute compression processing by an irreversible encoding process to the image data, and a data storing unit configured to store the image data, wherein in a case where the image data is image data including data of an image expressing information by a pixel having a value of ON and by a pixel having a value of OFF, the halftone processing is executed to the image data by the first halftone processing unit without executing the compression processing by the irreversible encoding process with the first image data encoding unit to store the processed image data in the data storing unit, and in a case where the image data is not image data including the data of the image expressing the information by the pixel having the value of ON and by the pixel having the value of OFF, the compression processing is executed to the image data by the irreversible encoding process with the first image data encoding unit without executing the halftone processing to the image data by the first halftone processing unit to store the processed image data in the data storing unit.

According to the present invention, at printing or the like, synthesized image data including data of an image such as a copy-forgery-inhibited pattern can be converted into image data having an optimal image data size without causing degradation in image quality which possibly damages the data of the image such as the copy-forgery-inhibited pattern, which is stored (spooled) in an HDD or the like.

Further features of the present invention will become apparent from the following description of exemplary embodiments (with reference to the attached drawings).

### BRIEF DESCRIPTION OF THE DRAWINGS

FIG. 1 is a diagram showing an entire configuration of an image processing system provided with an image processing apparatus according to embodiment 1;

FIG. 2 is a diagram showing an internal configuration of an image processing apparatus 102;

FIGS. 3A and 3B are functional block diagrams each showing the details of an image data encoding unit and an image data decoding unit according to embodiment 1;

FIG. 4 is a flowchart showing the process flow from the process of executing image processing to image data to be printed which is received from a computer 101 in the image processing apparatus 102 to the process of printing the processed image data by a printer 103 according to embodiment 1;

FIGS. 5A and 5B are functional block diagrams each showing the details of an image data encoding unit and an image data decoding unit according to embodiment 2; and

FIG. 6 is a flowchart showing the process flow from the process of executing image processing to an image data to be printed which is received from the computer 101 in the image processing apparatus 102 to the process of printing the processed image data by the printer 103.

### DESCRIPTION OF THE EMBODIMENTS

### Embodiment 1

Hereinafter, preferable embodiments according to the present invention will be explained by taking a case of printing synthesized image data including copy-forgery-inhibited pattern data as an example. Without mentioning, the present invention can be applied to the synthesized image data including the data of the image of QR code, glypfCode, or LVBC as described above or the like and is not limited to a case of the synthesized image data including the copy-forgery-inhibited pattern data. That is, when the synthesized image data includes data of an image directly or indirectly expressing constant information composed of character columns, numerical values or the like by a combination or an arrangement of pixels each having a value (information) of ON and pixels each having a value (information) of OFF, the present invention can be applied to all of such synthesized image data.

It should be noted that in a case of the copy-forgery-inhibited pattern, the pixel having the value of ON is a black pixel for monochrome print and is a cyan pixel, a magenta pixel, a yellow pixel or a black pixel for color print provided with each color material of CMYK. The pixel having the value of OFF is a white pixel for any of monochrome or color print. The copy-forgery-inhibited pattern is configured by arranging dots, which are formed of pixels other than the white pixel, on the background formed of the white pixels. Therefore, the copy-forgery-inhibited pattern is generally classified into four kinds of copy-forgery-inhibited patterns in total composed of a copy-forgery-inhibited pattern configured by a cyan pixel and a white pixel, a copy-forgery-inhibited pattern configured by a magenta pixel and a white pixel, a copy-forgery-inhibited pattern configured by a yellow pixel and a white pixel and a copy-forgery-inhibited pattern configured by a black pixel and a white pixel. Incidentally in RGB, a black color is expressed in numerical values of (R, G, B)=(0, 0, 0) and a white color is expressed in numerical values of (R, G, B)=(255, 255, 255). Therefore, for example, the copy-forgery-inhibited pattern data for monochrome print is data by a combination of a pixel of black (0, 0, 0) as the pixel having the value of ON and a pixel of white (255, 255, 255) as the pixel having the value of OFF.

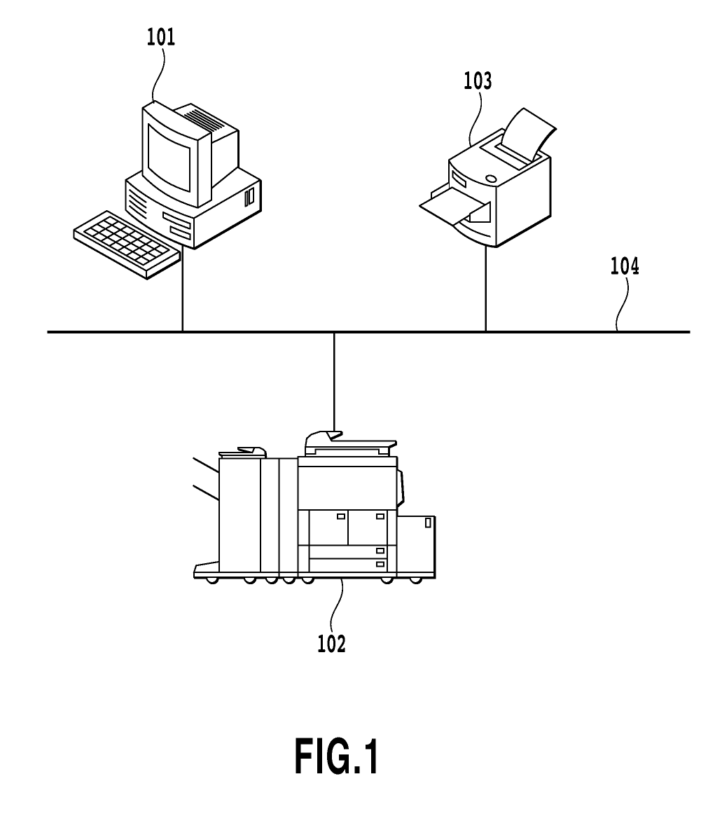

FIG. 1 is a diagram showing an entire configuration of an image processing system provided with an image processing apparatus according to embodiment 1. Reference number 101 is a computer (PC), reference number 102 is an image processing apparatus, and reference number 103 is an image output device (printer) for outputting (printing) image data. The computer 101, the image processing apparatus 102 and the printer 103 are connected through a network 104. Image data (PDL data) to be printed is transmitted from the computer 101 to the image processing apparatus 102, which interprets a PDL command thereof and based thereon, executes predetermined image processing to the image data. The image data (bit map data) subjected to the above image processing is printed by the printer 103. In the present embodiment, a print in a case where the image data (image data transmitted from the computer 101) to be processed is configured by copy-forgery-inhibited pattern data and document data is called “copy-forgery-inhibited pattern print” and a print in a case where it is configured only by document data is called “normal print”.

In regard to the image data to be processed, image data attribute information expressing an attribute of the image data is added as header information of the image data. For example, in a case where the image data is copy-forgery-inhibited pattern data, the image data attribute information indicating that the image data is the copy-forgery-inhibited pattern data is transmitted in a state of being added as the header information of the image data. In addition, in a case where the image data is document data, likewise the image data attribute information indicating that the image data is the document data is transmitted in a state of being added as the header information of the image data. The image data attribute information is referred to by the image processing apparatus 102 before executing the image processing for executing appropriate processing to the image data in the image processing apparatus 102.

It should be noted that In this figure, the image processing apparatus 102 and the printer 103 are illustrated as separate components, but may be configured by a single component.

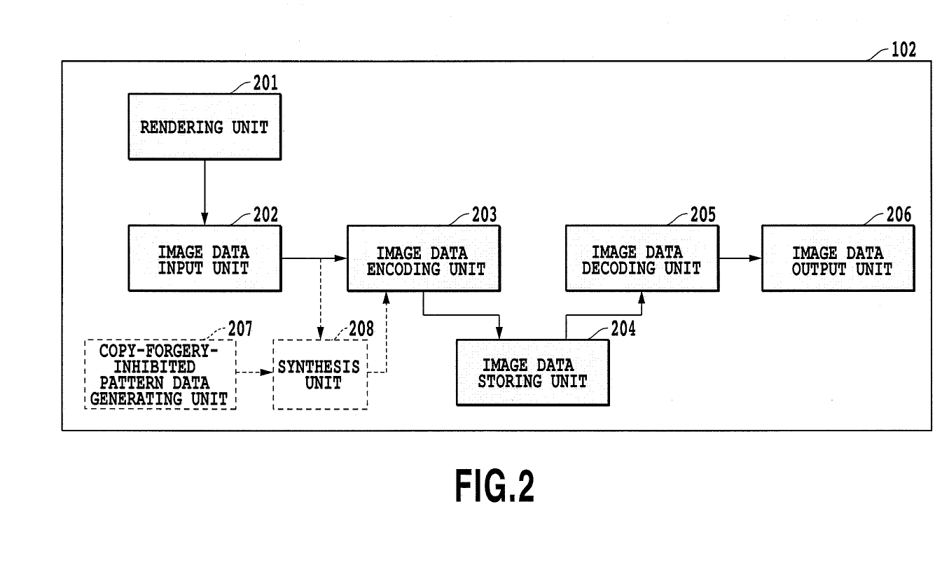

FIG. 2 is a diagram showing an internal configuration of the image processing apparatus 102.

Reference number 201 is a rendering unit which executes the processing of interpreting image data in PDL description transmitted from the computer 101 and imaging (bit mapping) information in regard to an object or a graphic provided as numerical data in calculations. It should be noted that in a case of a copy-forgery-inhibited pattern print, when the image data is composed of document data and copy-forgery-inhibited pattern data, the processing of synthesizing both the data to create document data with the copy-forgery-inhibited pattern (synthesized image data) is also executed together. On this occasion, in regard to the created synthesized image data, the image data attribute information indicating that the copy-forgery-inhibited pattern data is included therein is added as the header information of the corresponding synthesized image data.

Reference number 202 is an image data input unit and receives the rendered image data from a rendering unit 201 and transmits the received image data to an image data encoding unit 203 as needed.

Reference number 203 is the image data encoding unit and encodes (compresses) the image data received from the image data input unit 202. The details of the processing for this image data encoding unit 203 will be described later.

Reference number 209 is an image data storing unit and is configured by an HDD and the like.

Reference number 205 is an image data decoding unit and decodes (develops) the image data encoded by the image data encoding unit 203. The details of the processing for the image data decoding unit 205 will be described later.

Reference number 206 is an image data output unit and outputs the decoded image data received from the image data decoding unit 205 to the printer 103.

It should be noted that in a case of the copy-forgery-inhibited pattern print, it is explained that both the copy-forgery-inhibited pattern data and the document data as the image data to be printed are provided from the computer 101, but the copy-forgery-inhibited pattern print does not exclude the configuration of performing the copy-forgery-inhibited pattern print by receiving only the document data from the computer 101. It is possible to perform the copy-forgery-inhibited pattern print by a method in which the image processing apparatus 102 generates the copy-forgery-inhibited pattern data, which is then synthesized with the document data received from the computer 101. In such a case, as shown in broken lines of FIG. 2, a copy-forgery-inhibited pattern data generating unit 207 and a synthesis unit 208 are provided in the image processing apparatus 102. Therefore, in the present embodiment in which both the document data and the copy-forgery-inhibited pattern data as the image data in the copy-forgery-inhibited pattern print are transmitted to the image processing apparatus 102, the copy-forgery-inhibited pattern generating unit 207 and the synthesis unit 208 are not used.

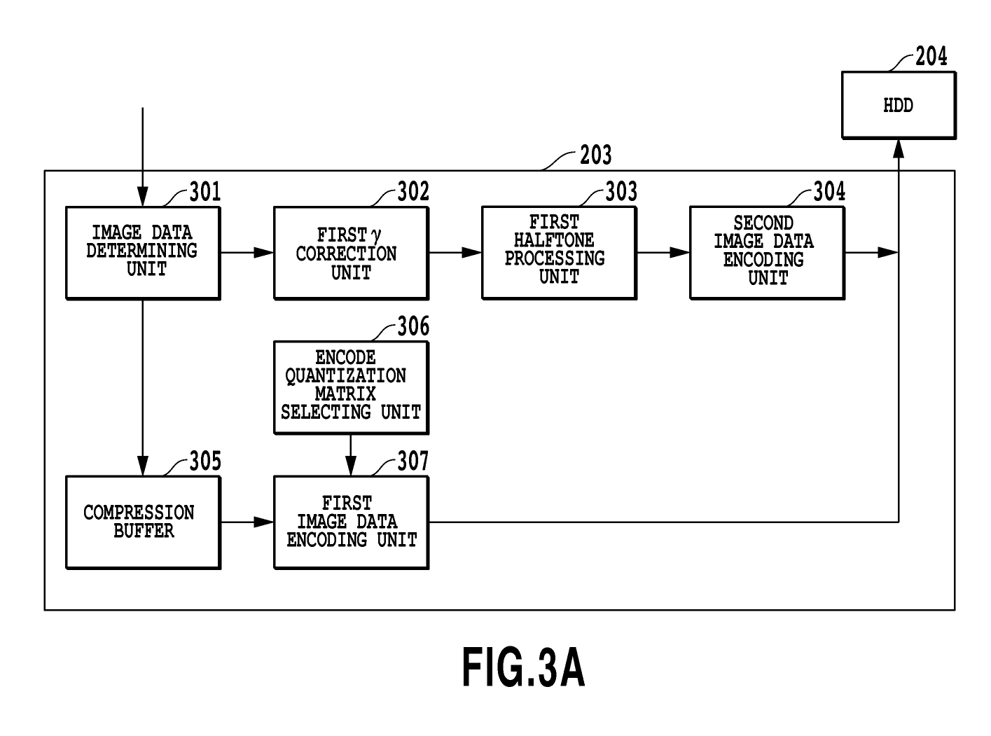

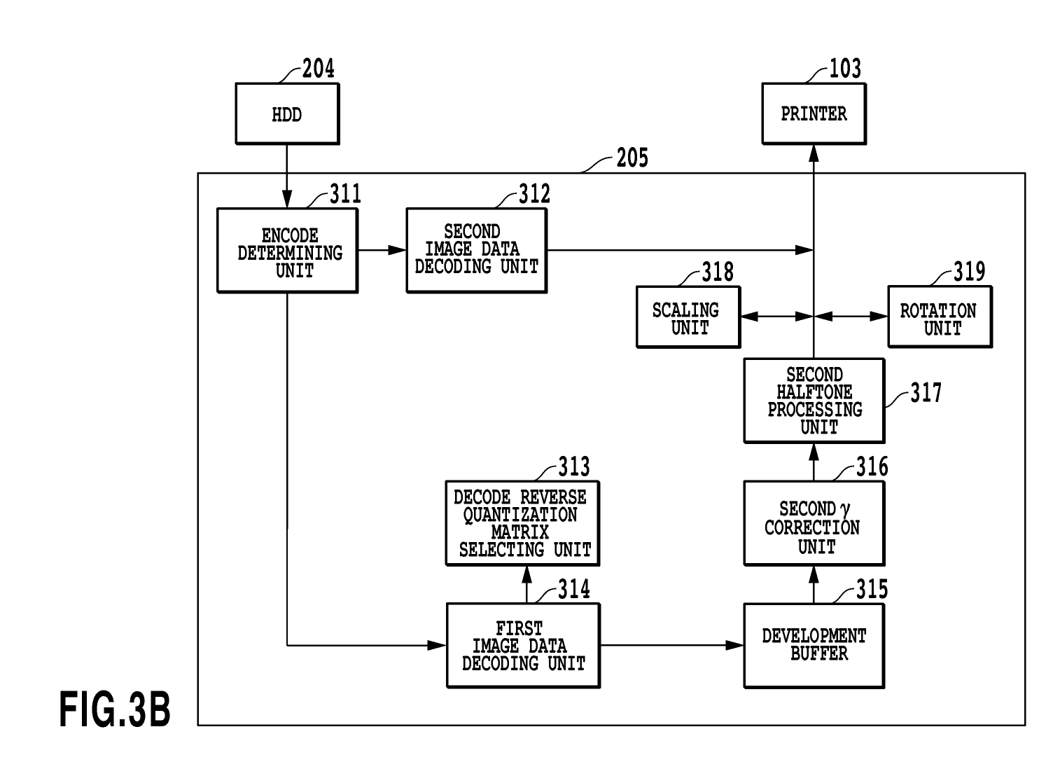

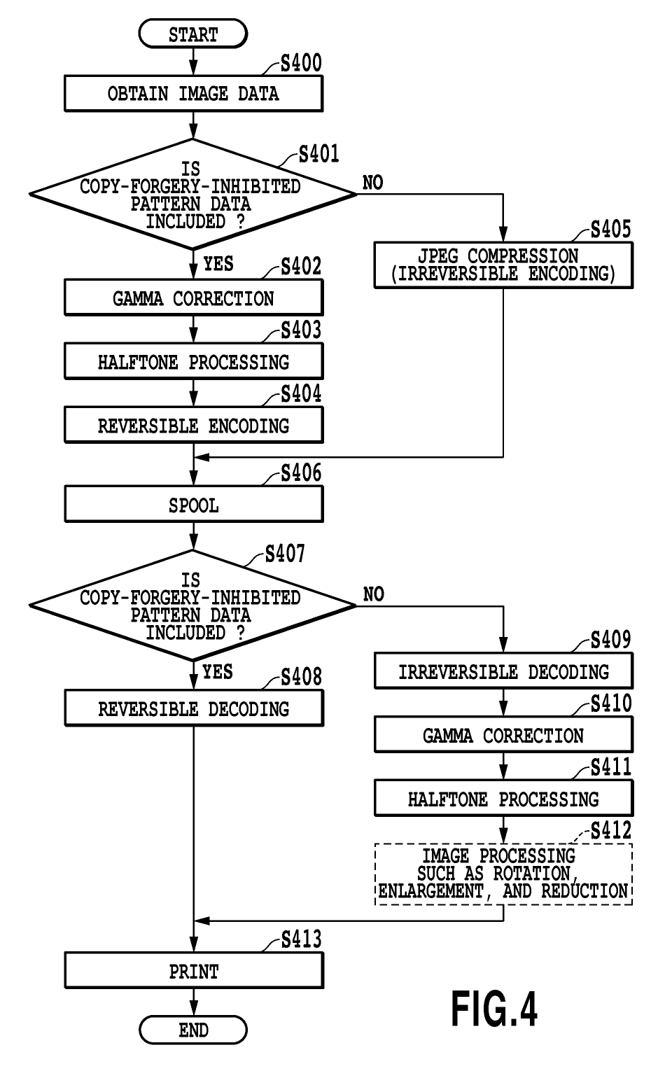

Next, the details of the processing in the image processing apparatus 102 according to the present embodiment will be explained with reference to FIG. 3A, FIG. 3B and FIG. 4.

FIG. 3A and FIG. 3B are functional block diagrams showing the details of the image data encoding unit 203 and the image data decoding unit 205 respectively. First, by referring to FIG. 3A, the image data encoding unit 203 will be explained.

An image data determining unit 301 determines whether or not copy-forgery-inhibited pattern data is included in the image data received from the computer 101. The determination on whether or not the copy-forgery-inhibited pattern data is included in the image data is made by referring to the image data attribute information added to the image data as the header information. It should be noted that the determination may be made by image recognition instead of referring to the image data attribute information.

A first gamma correction unit 302 executes gamma correction processing in accordance with a characteristic of the printer 103. γ value used in the gamma correction processing is determined by actually performing a test print in the printer 103 and measuring a density of the image data obtained by scanning the print matter.

A first halftone processing unit 303 executes halftone processing for expressing a halftone color using only colors of black and white.

A second image data encoding unit 304 executes compression processing by reversible encoding to the halftone-processed (binarized) image data.

A compression buffer 305 is a memory unit for temporarily storing image data.

An encode quantization matrix selecting unit 306 retains a plurality of quantization tables (quantization matrixes) having different compression rates (quantization scales) and outputs quantization matrixes in the order of a worse compression rate instead of less image quality degradation to the first image data encoding unit 307. It should be noted that each numerical value constituting the quantization matrix is in advance set to a predetermined value.

The first image data encoding unit 307 executes compression processing by irreversible encoding (JPEG) to the image data not including the copy-forgery-inhibited pattern data. That is, the first image data encoding unit 307 performs discrete cosine transform (DCT) to the image data, executes quantization processing to the transformed image data using the quantization matrix sequentially outputted from the encode quantization matrix selecting unit 306, and executes the processing of encoding the obtained quantization data. This processing is repeated until the image data is accommodated to reach a predetermined memory capacity, and finally the information of the selected quantization matrix is added to the image data attribute information.

Next, by referring to FIG. 3B, the image data decoding unit 205 will be explained.

An encode determining unit 311 executes processing of determining whether the encoded image data is the reversibly compressed image data (that is, includes copy-forgery-inhibited pattern data) or the irreversibly compressed image data (does not include copy-forgery-inhibited pattern data).

A second image data decoding unit 312 executes processing of decoding the reversibly compressed image data.

A decode reverse quantization matrix selecting unit 313 retains reverse quantization tables (reverse quantization matrixes) and outputs the reverse quantization matrix corresponding to the quantization matrix used at the quantization processing in the first image data encoding unit 307 to a first image data decoding unit 314.

The first image data decoding unit 314 executes processing of decoding the image data subjected to the irreversible encode compression. That is, the first image data decoding unit 314 executes processing of decompressing (developing) the image data subjected to JPEG compression, reversely quantizing the decompressed image data using the reverse quantization matrix outputted from the decode reverse quantization matrix selecting unit 313, and performing indiscrete cosine transform (IDCT) to the obtained reverse quantization data.

A development buffer 315 is a memory unit for temporarily storing image data in the same way as the compression buffer 305.

A second gamma correction unit 316 executes gamma correction processing in accordance with the characteristic of the printer 103 in the same way as the first gamma correction unit 302.

A second halftone processing unit 317 executes halftone processing for expressing a halftone color only using black and white colors in the same way as the first halftone processing unit 303.

A scaling unit 318 executes enlargement and reduction processing to the image data which is subjected to the gamma correction processing and the halftone processing after the decoding and which does not include the copy-forgery-inhibited pattern data, in a predetermined scaling rate by the conventional technology such as a bilinear process.

A rotation unit 319 executes processing of rotating the image data which is subjected to the gamma correction processing and the halftone processing after the decoding and which does not include the copy-forgery-inhibited pattern data, by a predetermined angle.

The image data encoding unit 203 and the image data decoding unit 205 configured as described above have the following features.

First, the first and second gamma correction units 302 and 316 are respectively located before the first and second halftone processing units 303 and 317. When the image data becomes in a state of being a binary value (or substantially a binary value) by the halftone processing, the gamma correction on condition of sequential gradation can not be made, raising the problem that the image printed by the printer 103 is changed in quality from an original image. Therefore, for making the gamma correction before the halftone processing, the first and second gamma correction units 302 and 316 are respectively located before the first and second halftone processing units 303 and 317.

Next, the image data not including the copy-forgery-inhibited pattern data is configured in such a manner that the image data is subjected to the irreversible compressing (JPEG compression) by the first image data encoding unit 307 and, after the decoding, the image data can be enlarged and reduced in any scaling rate by the scaling unit 318. The image data in a binarized state by the halftone processing changes remarkably in quality depending on the scaling rate, thereby leading to substantially limiting the scaling processing. Therefore, the image data not including the copy-forgery-inhibited pattern data is not subjected to the halftone processing, but to the JPEG compression, and the image data to which the halftone processing is executed after the decoding can be enlarged and reduced by the scaling unit 318.

Further, the image data not including the copy-forgery-inhibited pattern data is configured in such a manner that the image can be rotated by any angle by the rotation unit 319 after the decoding. There are some cases where the image data in a state of being binarized by the halftone processing originally changes in pixel density by being rotated depending on the characteristic of the printer 103. That is, the printer has the characteristic that the print performance is hard to be influenced in the main scan direction (even in a pixel group having a few number of pixels successive in the main scan direction, a print can be accurately performed) and is easy to be influenced in the sub scan direction, raising the problem that the density expressed on a printed matter becomes thin due to the influence. Therefore, the image data not including the copy-forgery-inhibited pattern data is not subjected to the halftone processing, but to the JPEG compression and after the decoding, the image data subjected to the halftone processing can be subjected to the rotation processing by the rotation unit 319.

It should be noted that in a case of a print by a method in which a user gives a print instruction to the image data stored in the HDD 204, the instructed image data is transmitted from the HDD 204 to the image data decoding unit 205, wherein the predetermined decode processing is executed to the image data, which is then printed by the printer 103.

As the image data encoding unit 203 and the image data decoding unit 205 are configured as described above, the image processing apparatus according to the present invention executes, when the image data to be printed is the image data including the copy-forgery-inhibited pattern data, not the JPEG compression, but the halftone processing to the image data for spooling. This prevents the event that the copy-forgery-inhibited pattern data is damaged and degraded by the JPEG compression, allowing the image data to be made small in data size.

FIG. 4 is a flow chart showing the process flow from the process of executing image processing in the image processing apparatus 102 to image data to be printed which is received from the computer 101 to the process of printing the processed image data by the printer 103, according to the present embodiment.

First, at step 400 the image processing apparatus 102 obtains image data to be printed from the computer 101. Hereinafter, at this step, assuming that the image data composed of document data and copy-forgery-inhibited pattern data is obtained from the computer 101 (that is, the document data and the copy-forgery-inhibited pattern data are sequentially transmitted from the computer 101), an explanation is added as needed. Synthesized image data rendered by the rendering unit 201 is generated based upon the obtained image data and the generated synthesized image data is transmitted to the image data encoding unit 203 via the image data input unit 202. It should be noted that the image data attribute information indicating inclusion of the copy-forgery-inhibited pattern data is added as the header information to the synthesized image data as described before.

At step 401 the image data determining unit 301 in the image data encoding unit 203 determines whether or not the copy-forgery-inhibited pattern data is included in the image data. When it is determined that the copy-forgery-inhibited pattern data is included in the image data, the image data is transmitted to the first gamma correction unit 302. On the other hand, when it is determined that the copy-forgery-inhibited pattern data is not included in the image data, the image data is transmitted to the compression buffer 305. Here, when it is determined that the copy-forgery-inhibited pattern data is included in the image data, the image data is transmitted to the first gamma correction unit 302.

At step 402 the first gamma correction unit 302 makes gamma correction to the image data including the copy-forgery-inhibited pattern data (synthesized image data). The synthesized image data subjected to the gamma correction is transmitted to the first halftone processing unit 303.

At step 403 the first halftone processing unit 303 executes halftone processing to the synthesized image data subjected to the gamma correction. The synthesized image data subjected to the halftone processing is transmitted to the second image data encoding unit 304.

At step 404 the second image data encoding unit 304 executes compression processing by a reversible encoding process to the synthesized image data subjected to the halftone processing.

On the other hand, when at step 401 it is determined that the copy-forgery-inhibited pattern data is not included, at step 405 the first image data encoding unit 307 executes compression processing by an irreversible encoding process (JPEG) to the image data (only document data).

It should be noted that when at step 404 and at step 405 the image data is encoded, information by which process the image data is encoded (compressed) is added to the image data attribute information.

At step 406 the image processing apparatus 102 stores the encoded image data in the HOD 204 as a data storage unit. In the present embodiment of performing a print by the printer 103 as soon as the image processing is completed in response to a print instruction from the computer 101, this “storage” can be replaced by “spool” in expression. It should be noted that herein the synthesized image data is compressed by the reversible encoding process for storing, but is stored in the HDD 204 in a state where the image data attribute information showing inclusion of the copy-forgery-inhibited pattern data and being compressed by the reversible encoding process is added.

In this way, when the image data to be processed includes the copy-forgery-inhibited pattern data, not the JPEG compression but the halftone processing is executed to the image data and the image data subjected to the halftone processing is stored in the HDD 204. Therefore, it is restricted fro the image of the copy-forgery-inhibited pattern data to be degraded and damaged, and the data size of the image data is restricted to be made small. On the other hand, in a case where the image data to be processed does not include the copy-forgery-inhibited pattern data, the image data the data size of which is restricted by the JPEG compression is stored in the HDD 204.

At step 407 the image processing apparatus 102 transmits the image data stored (spooled) in the HDD 204 to the encode determining unit 311 and the encode determining unit 311 determines whether or not the image data includes the copy-forgery-inhibited pattern data by referring to the image data attribute information. When it is determined that the image data includes the copy-forgery-inhibited pattern data, the encode determining unit 311 transmits the image data to the second image data decoding unit 312 (to step 408). When it is determined that the image data does not include the copy-forgery-inhibited pattern data, the encode determining unit 311 transmits the image data to the first image data decoding unit 314 (to step 409). In a case where the image data is the synthesized image data, it is determined that the copy-forgery-inhibited pattern data is included, and the process goes to step 408.

At step 408 the second image data decoding unit 312 reversibly decodes (develops) the synthesized image data including the copy-forgery-inhibited pattern data. The developed image data is outputted via the image data output unit 206 to the printer 103.

On the other hand, at step 409 the first image data decoding unit 314 irreversibly decodes (develops) the synthesized image data not including the copy-forgery-inhibited pattern data. The developed image data is outputted to the second gamma correction unit 316.

At step 410 the second gamma correction unit 316 makes gamma correction to the developed image data. The image data subjected to the gamma correction is transmitted to the second halftone processing unit 317.

At step 411 the second halftone processing unit 317 executes halftone processing to the image data subjected to the gamma correction. The image data subjected to the halftone processing is transmitted to the scaling unit 318 or the rotation unit 319 in response to a user's instruction.

At step 412, the scaling unit 318 or the rotation unit 319 respectively executes enlargement/reduction or rotation processing to the image data subjected to the halftone processing in accordance with the content instructed by a user. The image data to which the predetermined processing is executed is transmitted via the image data output unit 206 to the printer 103.

At step 413, the printer 103 prints out the developed image data. In regard to the developed image data in a case of the copy-forgery-inhibited pattern data, because of no JPEG compression, the damage of the copy-forgery-inhibited pattern data is restricted and the dot by the pixel having a value of ON is not damaged, thus reproducing the copy-forgery-inhibited pattern on a print matter.

As described above, according to the present embodiment, upon printing the synthesized image data including the copy-forgery-inhibited pattern data, it is possible to encode the image data to be in an optimal image data size without creating image quality degradation as much as to damage the copy-forgery-inhibited pattern data and then store it in the HDD. In addition, in a case of a normal print, the data size of the image data is efficiently compressed by the JPEG compression, and therefore, the HDD is prevented from being consumed by a large amount.

### Embodiment 2

According to embodiment 1, in a case where the copy-forgery-inhibited pattern data is included in the image data to be processed, the image data is subjected to the halftone processing without the JPEG compression. Next, in a case where the image data has a high resolution more than a predetermined resolution even if the image data to be processed does not include the copy-forgery-inhibited pattern data, the configuration of executing the halftone processing without the JPEG compression will be explained as embodiment 2.

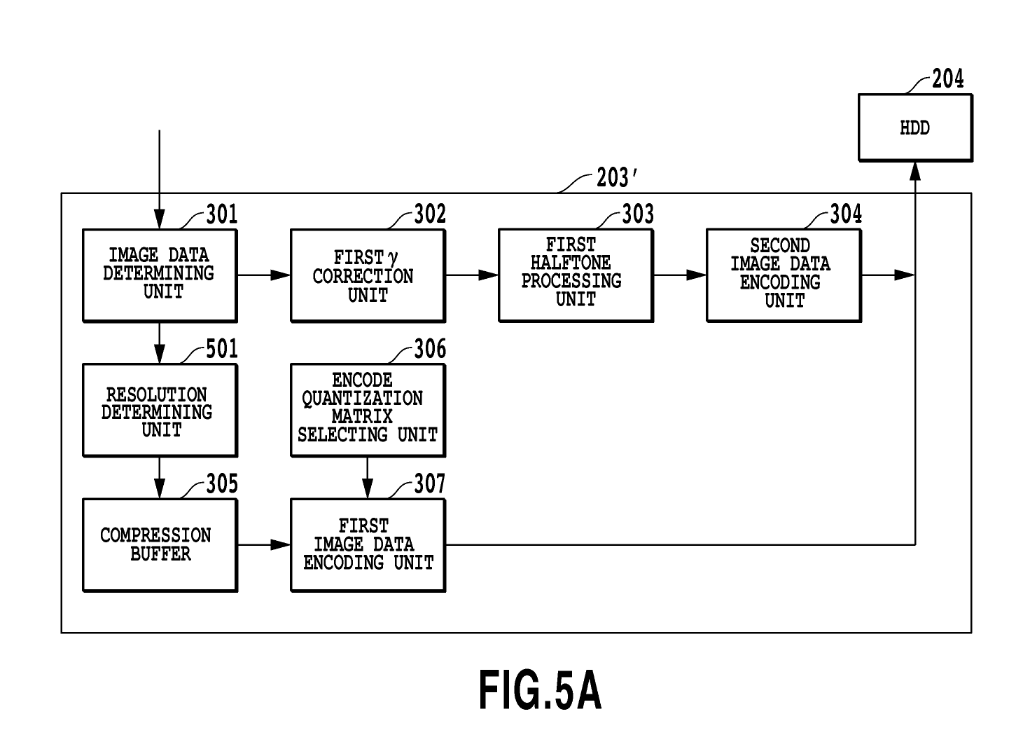

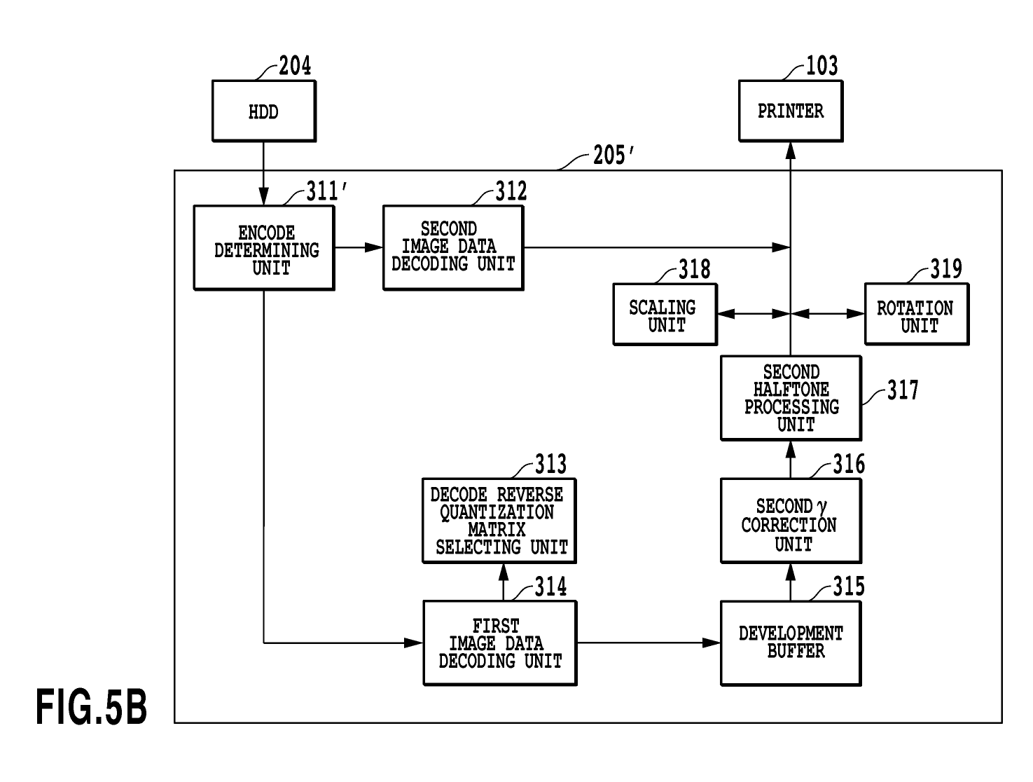

FIG. 5A and FIG. 5B are functional block diagrams each showing the details of an image data encoding unit 203′ and an image data decoding unit 205′ according to the present embodiment. It should be noted that components in common to the image data encoding unit 203 and the image data decoding unit 205 according to embodiment 1 are referred to as identical codes and the explanation is eliminated.

Reference number 501 is a resolution determining unit which obtains a resolution of image data which is determined not to include copy-forgery-inhibited pattern data at the image data determining unit 301 and determines whether or not the obtained resolution is more than a predetermined resolution in advance set. The resolution is obtained by referring to header information of the image data (image data attribute information). That is, in a case of the present embodiment, to the image data to be processed which is transmitted from the computer 101, information in regard to the resolution is added as the image data attribute information.

Reference number 311′ is an encode determining unit and in the same way as the encode determining unit 311 in the embodiment 1, determines whether or not the encoded image data includes the copy-forgery-inhibited pattern data. In addition to it, the encode determining unit 311′ determines whether or not the image data is the image data having the high resolution. The determination on the resolution is also made by referring to the header information of the image data (image data attribute information).

The other respective units are the same as the image data encoding unit 203 and the image data decoding unit 205 according to embodiment 1.

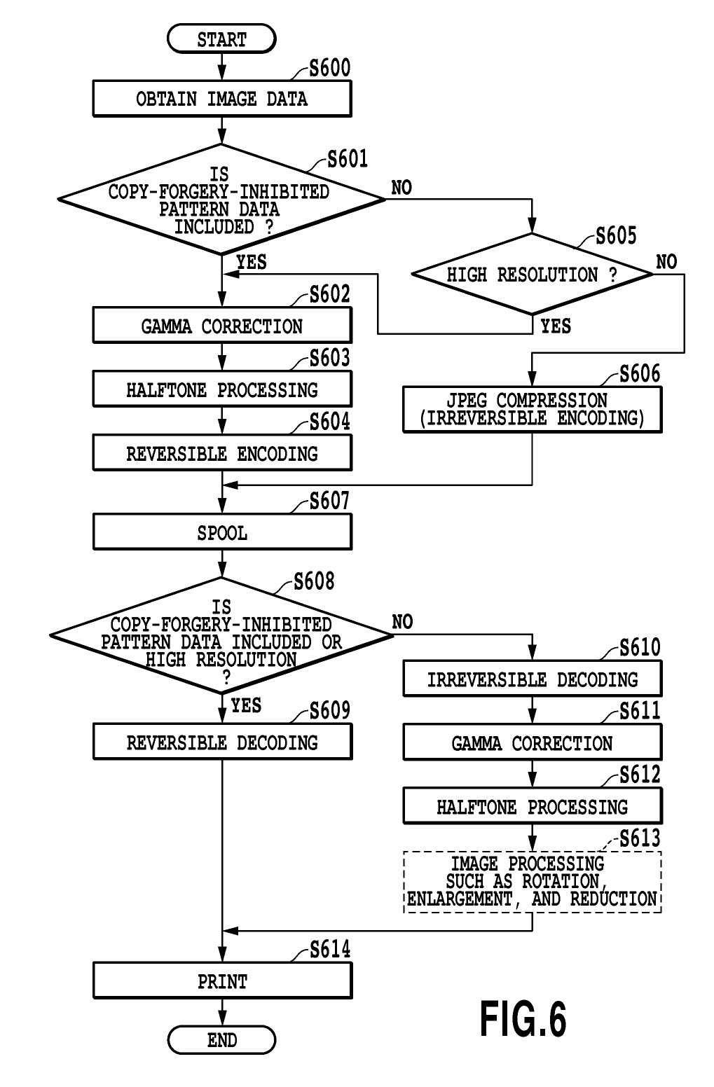

FIG. 6 is a flowchart showing the process flow from the process of executing image processing in the image processing apparatus 102 to image data to be printed which is received from the computer 101 to the process of printing the processed image data by the printer 103. It should be noted that an explanation of components in common to the flow chart in FIG. 4 according to embodiment 1 is simplified or eliminated and herein different points from embodiment 1 will be mainly explained.

When the image processing apparatus 102 obtains image data to be processed at step 600, at step 601 the image data determining unit 301 of the image data encoding unit 203′ determines whether or not the image data includes copy-forgery-inhibited pattern data.

When it is determined that the image data includes the copy-forgery-inhibited pattern data, the process goes to step 602, and the image data compressed by the reversible encoding process via the execution of the gamma correction processing and the halftone processing is stored in the HDD 204 (steps 602, 603, 604 and 605). On the other hand, when it is determined that the image data does not include the copy-forgery-inhibited pattern data, the process goes to step 605.

At step 605, the resolution determining unit 501 obtains a resolution of the image data to determine whether or not the obtained resolution is more than a predetermined resolution. In a case where the obtained resolution is more than the predetermined resolution, the process goes to step 602, and in a case where the obtained resolution is less than the predetermined resolution, the process goes to step 606.

Here, there is assumed that the image data which does not include the copy-forgery-inhibited pattern data and has the resolution of 2400 dpi is obtained from the computer 101 and the predetermined resolution is in advance set to 1200 dpi. In this case, since the resolution of the image data to be processed is more than the predetermined resolution, the process goes to step 602. Further, the image data to be processed is subjected to gamma correction processing and halftone processing without JPEG compression (step 602 and step 603), which is spooled in the HDD 204 (step 607).

If the resolution of the image data to be processed is 600 dpi, when it is determined that it is less than the predetermined resolution, the process goes to step 606, wherein after the image data is subjected to JPEG compression, it is spooled in the HDD 204 (step 607).

At step 608, the encode determining unit 311′ determines whether the encoded image data includes the copy-forgery-inhibited pattern data or is the image data more than the predetermined resolution. In a case where the image data includes the copy-forgery-inhibited pattern data or the resolution thereof is more than the predetermined resolution, the development processing by a reversible decoding process is executed (step 609).

On the other hand, in a case where the image data does not include the copy-forgery-inhibited pattern data or the resolution thereof is less than the predetermined resolution, the process goes to step 610. Since each processing of step 610 to step 613 is the same as that of step 409 to step 412 according to embodiment 1, the explanation is eliminated.

At step 614, the printer 103 prints out the developed image data. Since the image data developed in a case of the copy-forgery-inhibited pattern print or the high resolution image data print is not subjected to the JPEG compression, the damage of the data is restricted and the high quality image is reproduced on a print matter.

As described above, according to the present embodiment, even in a case of not only the synthesized image data including the copy-forgery-inhibited pattern data but also the image data having the high resolution more than the predetermined resolution, it is possible to encode the image data to be in an optimal image data size, which is then stored in the HDD.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the preset invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-013119, filed Jan. 25, 2010, which is hereby incorporated by reference herein in its entirety.

1. An image processing apparatus comprising:
a first halftone processing unit configured to execute halftone processing to image data;
a first image data encoding unit configured to execute compression processing by an irreversible encoding method to the image data; and
a data storing unit configured to store the image data,
wherein
in a case where the image data is image data including data of an image expressing information by a pixel having a value of ON and by a pixel having a value of OFF, the halftone processing is executed to the image data by the first halftone processing unit without executing the compression processing by the irreversible encoding method with the first image data encoding unit to store the processed image data in the data storing unit, and
in a case where the image data is not image data including the data of the image expressing the information by the pixel having the value of ON and by the pixel having the value of OFF, the compression processing is executed to the image data by the irreversible encoding method with the first image data encoding unit without executing the halftone processing to the image data by the first halftone processing unit to store the processed image data in the data storing unit.

2. An image processing apparatus according to claim 1, further comprising:
a second image data encoding unit configured to execute compression processing by a reversible encoding method to the image data to which the halftone processing is executed by the first halftone processing unit.

3. An image processing apparatus according to claim 1, further comprising:
a first gamma correction unit configured to execute gamma correction processing to the image data to be subjected to the halftone processing by the first halftone processing unit.

4. An image processing apparatus according to claim 2, further comprising:
a first image data decoding unit configured to, in a case where the image data read from the data storing unit is the image data to which the compression processing by the irreversible encoding method is executed by the first image data encoding unit, develop the image data; and
a second image data decoding unit configured to, in a case where the image data read from the data storing unit is the image data to which the compression processing by the reversible encoding method is executed by the second image data encoding unit, develop the image data.

5. An image processing apparatus according to claim 4, further comprising:
a second halftone processing unit configured to execute halftone processing to the image data developed by the first image data decoding unit.

6. An image processing apparatus according to claim 5, further comprising:
a second gamma correction unit configured to execute gamma correction processing to the image data developed by the first image data decoding unit before executing the halftone processing thereto by the second halftone processing unit.

7. An image processing apparatus according to claim 5, further comprising:
a scaling unit configured to execute processing of enlarging or reducing at a predetermined rate the image data to which the halftone processing is executed by the second halftone processing unit.

8. An image processing apparatus according to claim 5, further comprising:
a rotation unit configured to execute processing of rotating at a predetermined angle the image data to which the halftone processing is executed by the second halftone processing unit.

9. An image processing apparatus comprising:
a first halftone processing unit configured to execute halftone processing to image data;
a first image data encoding unit configured to execute compression processing by an irreversible encoding method to the image data; and
a data storing unit configured to store the image data,
wherein
in a case where the image data is image data including data of an image expressing information by a pixel having a value of ON and by a pixel having a value of OFF or the image data is image data having resolution more than a predetermined resolution, the halftone processing is executed to the image data by the first halftone processing unit without executing the compression processing by the irreversible encoding method with the first image data encoding unit to store the processed image data in the data storing unit, and
in a case where the image data is not image data including the data of the image expressing the information by the pixel having the value of ON and by the pixel having the value of OFF and the image data is image data having resolution less than the predetermined resolution, the compression processing is executed to the image data by the irreversible encoding method with the first image data encoding unit without executing the halftone processing to the image data by the first halftone processing unit to store the processed image data in the data storing unit.

10. An image processing method comprising:
a first halftone processing step of executing halftone processing to image data;
a first image data encoding step of executing compression processing by an irreversible encoding method to the image data; and
a data storing step of storing the image data,
wherein
in a case where the image data is image data including data of an image expressing information by a pixel having a value of ON and by a pixel having a value of OFF, the halftone processing is executed to the image data by the first halftone processing step without executing the compression processing by the irreversible encoding method with the first image data encoding step to store the processed image data in the data storing step, and
in a case where the image data is not image data including the data of the image expressing the information by the pixel having the value of ON and by the pixel having the value of OFF, the compression processing is executed to the image data by the irreversible encoding method with the first image data encoding step without executing the halftone processing to the image data by the first halftone processing step to store the processed image data in the data storing step.
